(19) United States
(12) Patent Application Publication
(10) Pub. No.: US 2010/0091730 A1
(43) Pub. Date: Apr. 15, 2010

(54) APPARATUS AND METHOD FOR DETERMINING UPLINK SCHEDULING PRIORITY IN BROADBAND WIRELESS COMMUNICATION SYSTEM

(75) Inventors: Yun-Jik JANG, Seoul (KR); Seung-Joo Maeng, Seoul (KR); Chang-Soo Park, Seoul (KR); Byung-Chan Ahn, Seoul (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/572,951

(22) Filed: Oct. 2, 2009

(30) Foreign Application Priority Data
Oct. 2, 2008 (KR) 10-2008-0097216

(51) Int. Cl. H04W 72/12

(52) U.S. Cl. 370/329

(57) ABSTRACT

An apparatus and method for determining an uplink scheduling priority in a broadband wireless communication system are provided. The apparatus includes a basic priority determination unit for calculating a basic priority metric of at least one Mobile Station (MS), a calculation unit for calculating a correction value for considering an interference level with respect to the basic priority metric by using downlink channel quality of each MS, and a final priority determination unit for determining an uplink scheduling priority by calculating a final priority metric by using the correction value.

### PRIORITY

The present application claims priority under 35 U.S.C. §119(a) to a Korean patent application filed in the Korean Intellectual Property Office on Oct. 2, 2008 and assigned Serial No. 10-2008-0097216, the contents of which are incorporated by reference.

### BACKGROUND OF THE INVENTION

1. Field of the Invention

The present invention relates generally to a broadband wireless communication system, and more particularly, to an apparatus and method for determining an uplink scheduling priority in a broadband wireless communication system.

2. Description of the Related Art

In a cellular-type wireless communication system, a plurality of Base Stations (BSs) deployed in fixed locations have respective cells that they manage, and each Mobile Station (MS) performs wireless communication with an BS which manages a serving cell of each MS. In this case, a wireless link from a BS to an MS is referred to as a downlink, and a wireless link from the MS to the BS is referred to as an uplink.

A Code Division Multiple Access (CDMA)-based wireless communication system performs uplink communication by using circuit transmission. Accordingly, MSs always transmit constant data, and a BS only controls a data transfer rate of each MS. When determining the data transfer rate of each MS, the BS collectively increases or decreases data transfer rates of MSs in a cell according to self-cell interference, other-cell interference, a ratio of a thermal noise sum to thermal noise (hereinafter, Rise over Thermal (RoT)) size. An RoT value of each cell is maintained at a specific level, and thus a coverage of each cell is constantly maintained, and each MS can have a data transfer rate above the specific level.

On the contrary, when using an Orthogonal Frequency Division Multiplexing (OFDM)/Orthogonal Frequency Division Multiple Access (OFDMA)-based wireless communication system, uplink communication is performed by using packet transmission. Therefore, each MS temporarily transmits data, and the BS performs scheduling to determine a specific MS for transmitting specific-sized data at a specific time. For this, the BS calculates a data transfer rate with which each MS can transmit uplink data by using information reported from each MS, and thereafter determines priorities of MSs. For example, the BS calculates a headroom of an MS with a specific Modulation and Coding Scheme (MCS) by using an MCS level for a Transmit (Tx) packet of the MS and a power value used for packet transmission. In addition, by using the headroom, the BS determines a scheduling priority so that the scheduling priority is in proportion to a data transfer rate when the specific MCS level is used.

When using the OFDM/OFDMA-based wireless communication system, MSs included in the same cell use different radio resources, and thus self-cell interference occurring in a CDMA-based wireless communication system does not occur. Instead, only other-cell interference occurs. Since the self-cell interference does not occur, it is unable to use a method of maintaining an RoT of each cell to a constant level by controlling self-cell interference through regulation of a data transfer rate of an MS, similarly to the CDMA-based wireless communication system. Therefore, there is a need for a method whereby the RoT of each cell is maintained to equal to or less than a specific level in the OFDM/OFDMA-based broadband wireless communication system.

### SUMMARY OF THE INVENTION

To address the above-discussed deficiencies of the prior art, an aspect of the present invention is to provide an apparatus and method for maintaining a Rise over Thermal (RoT) to equal to or less than a reference value in a broadband wireless communication system.

An aspect of the present invention is to provide an apparatus and method for reducing other-cell interference caused by uplink communication in a broadband wireless communication system.

An aspect of the present invention is to provide an apparatus and method for determining an uplink scheduling priority by considering a level of other-cell interference in a broadband wireless communication system.

An aspect of the present invention is to provide an apparatus and method for determining an uplink scheduling priority by using downlink channel quality in a broadband wireless communication system.

An aspect of the present invention is to provide an apparatus and method for determining an uplink scheduling priority to decrease a priority of a Mobile Station (MS) having poor downlink channel quality in a broadband wireless communication system.

According to the present invention, a Base Station (BS) apparatus in a broadband wireless communication system includes a basic priority determination unit for calculating a basic priority metric of each MS, a calculation unit for calculating a correction value for considering an interference level with respect to the basic priority metric by using downlink channel quality of each MS, and a final priority determination unit for determining an uplink scheduling priority by calculating a final priority metric by using the correction value.

According to the present invention, a method of operating a BS in a' roadband wireless communication system includes calculating a basic priority metric of each MS, calculating a correction value for considering an interference level with respect to the basic priority metric by using downlink channel quality of each MS, and determining an uplink scheduling priority by calculating a final priority metric by using the correction value.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A and FIG. 1B are block diagrams of a BS in a broadband wireless communication system according to the present invention; and

FIG. 2 illustrates a process of determining an uplink scheduling priority by a BS in a broadband wireless communication system according to the present invention.

### DETAILED DESCRIPTION OF THE EMBODIMENTS

The figures and the various embodiments used to describe the principles of the present disclosure are by way of illustration only and should not be construed in any way to limit the scope of the disclosure. Those skilled in the art will understand that the principles of the present disclosure may be implemented in any suitably arranged wireless communication system. Detailed descriptions of constructions or processes known in the art may be omitted for the sake of clarity and conciseness.

Hereinafter, a technique for reducing other-cell interference caused by uplink transmission in a broadband wireless communication system will be described. Although a wireless communication system based on an OFDM/OFDMA-based wireless communication system will be described hereinafter for example, the present invention can also apply to other types of wireless communication systems.

Technical grounds of the present invention for reducing other-cell interference will be described below.

To reduce the other-cell interference in the broadband wireless communication system according to the present invention, a BS decreases an uplink scheduling priority of an MS. Accordingly, data transmission opportunity of an MS causing strong other-cell interference relatively decreases, and thus the other-cell interference decreases as a whole.

A method of determining the priority to decrease the uplink scheduling priority of the MS causing strong other-cell interference is performed as follows. First, the BS calculates a basic priority metric of each MS without considering existence of interference. For example, the basic priority metric can be calculated according to a Proportional Fair (PF) scheme using a headroom. The headroom is a parameter for representing a ratio of maximum Transmit (Tx) power to currently used Tx power of the MS, and is generally used as a normalized value for a specific Modulation and Coding Scheme (MCS) level. For example, the basic priority metric based on the PF scheme is calculated by Equation (1) as follows:

$$Basic priority = \frac{{R}_{h} \times L ( MCS )}{{R}_{t}^{v}} \\ = \frac{{R}_{h}}{{R}_{t}^{v}} \times \frac{{SINR}_{req} ( QPSK \frac{1}{2} ) / MPR ( QPSK \frac{1}{2} )}{{SINR}_{req} ( {MCS}_{new} ) / MPR ( {MCS}_{new} )} \qquad ( 1 )$$

In Equation (1) above, Basic priority denotes a basic priority index, Rₕ denotes a normalized headroom of an MS, L(MCS) denotes a value converted to a data transfer rate when the normalized headroom is used as an MCS level, Rₜ denotes an average data transfer rate of the MS, v denotes a weight for regulating a contribution level of the average data transfer rate, SINR_{req}(MCS) denotes a minimum request Signal to Interference and Noise Ratio (SINR) of the MCS level, and MPR(MCS) denotes the number of information bits per symbol of the MCS level.

The headroom is a value depending on channel quality between the MS and the BS. The smaller the size of the headroom, the worse the channel quality. For example, if the MS and the BS are far from each other, a signal loss is relatively large, thereby increasing power required to transmit a signal generated according to a reference MCS level. As a result, a size of the headroom decreases, and thus a basic priority decreases. On the contrary, if the MS and the BS are near each other, the signal loss is relatively small, thereby decreasing power required to transmit the signal generated according to the reference MCS level. As a result, the size of the headroom increases, and thus the basic priority increases.

If the uplink scheduling priority is determined by using only the basic priority index, an average transfer rate is characterized in Equation (2) as follows:

(Rₜ^{v})_{dB}∝(Rₕ)_{dB}+(L(MCS))_{dB} (2)

In Equation (2), Rₕ denotes a normalized headroom of an MS, L(MCS) denotes a value for converting the normalized headroom into a data transfer rate when using an MCS level, and Rₜ^{v} denotes the v^{th} power of an average data transfer rate of the MS.

As shown in Equation (2), when only the basic priority metric is used, an average data transfer rate varies depending on the headroom and the MCS level, which is irrelevant to an interference level. Therefore, the BS of the present invention corrects the basic priority metric according to an interference level of each MS and thus calculates a final priority metric by considering existence of interference.

The interference level is estimated by using a headroom and a downlink Carrier to Interference and Noise Ratio (CINR), which represents channel quality. The higher the CINR, the better the channel quality. In general, when an MS approaches a cell boundary, the downlink CINR of the MS decreases. Therefore, it can be seen that an MS having a low downlink CINR is located near a cell boundary, i.e., a region close in distance to a different cell. An uplink Tx signal of the MS located in the cell boundary causes a strong other-cell interference, and thus it can be seen that the uplink signal of the MS causes a strong other-cell interference when the downlink CINR of the MS is low. Therefore, according to the relationship between the CINR and the interference level, the BS calculates the final priority metric such that an MS having a low downlink CINR has a low priority. For this, the CINR and the headroom are used to calculate a correction value for converting the basic priority metric into the final priority metric. For example, the correction value is calculated by Equation (3) as follows:

$$CINR Factor = {10}^{\frac{- α ⌊ {( {R}_{h} )}_{dB} - {( DLCINR )}_{dB} ⌋}{10}} \qquad ( 3 )$$

In Equation (3), CINR Factor denotes a correction value for considering an interference level, α denotes a weight for regulating a contribution level of a headroom and a downlink CINR, Rₕ denotes a normalized headroom of an MS, DLCINR denotes a downlink CINR of the MS, and └•┘ denotes a floor function.

As shown in Equation (3), the correction value is obtained by calculating 10 to the power of the product between a specific weight and a maximum integer less than a difference between the headroom and the downlink CINR. Therefore, the higher the difference between the headroom and the downlink CINR, the lower the correction value. The correction value represents the difference between the headroom and the downlink CINR, and may also represent a characteristic difference between an uplink channel and a downlink channel. For example, an MS located near a different cell has a low downlink CINR, and thus a correction value of the MS decreases. An MS located far from the different cell has a high downlink CINR, and thus the correction value of the MS increases. In this case, the greater the weight α, the less the correction value of the MS having the low downlink CINR.

When the uplink scheduling priority is determined by using the final priority metric, the average transfer rate is characterized by Equation (4) as follows:)

(Rₜ^{v})_{dB}∝(Rₕ)_{dB}+(L(MCS))_{dB}−α((Rₕ)_{dB}−(DLCINR)_{dB}) (4)

In Equation (4), Rₕ denotes a normalized headroom of an MS, L(MCS) denotes a value for converting the normalized headroom into a data transfer rate when using an MCS level, and Rₜ^{v} denotes the v^{th} power of an average data transfer rate of the MS, α denotes a weight for regulating a contribution level of a headroom and a downlink CINR, and DLCINR denotes a downlink CINR of the MS.

By determining the uplink scheduling priority as described above, an MS located near a different cell is assigned with a low scheduling priority, thereby decreasing a data transfer rate of the MS. As a result, other-cell interference decreases. For example, when there are two MSs having the same basic priority index, an MS located near a different cell potentially causes strong other-cell interference, and thus a BS decreases an average data transfer rate by decreasing a priority of the MS. In addition, an MS located far from the different cell causes small other-cell interference, and thus the BS increases the average data transfer rate by increasing a priority of the MS. Accordingly, other-cell interference decreases as a whole.

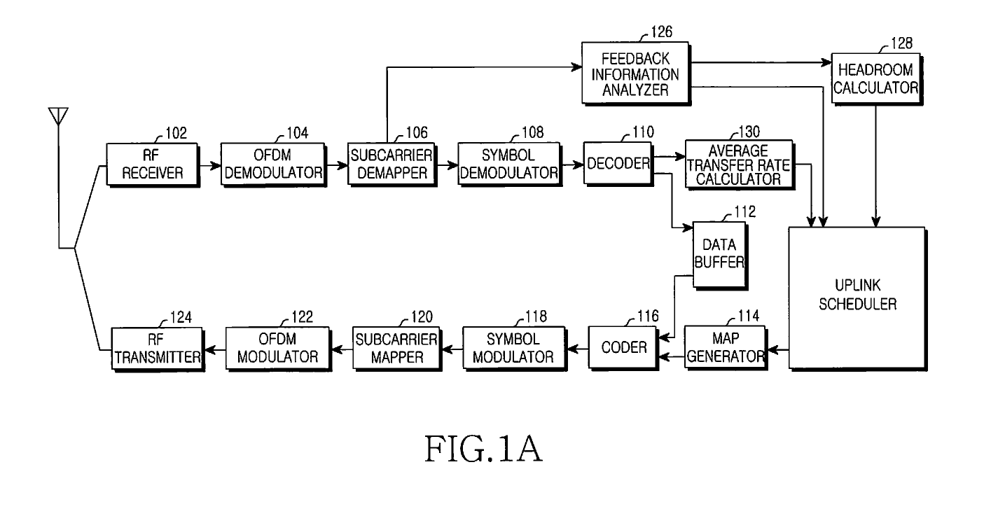

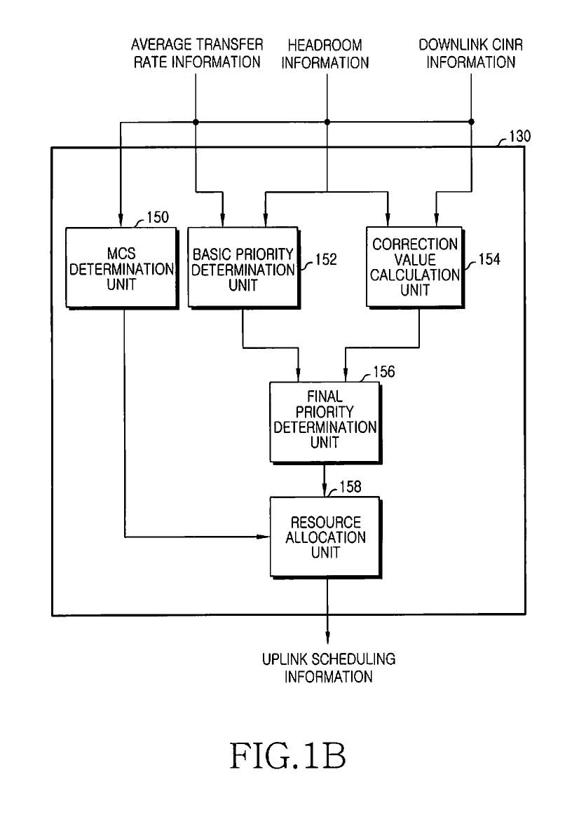

FIG. 1A and FIG. 1B are block diagrams of a BS in a broadband wireless communication system according to the present invention.

Referring to FIG. 1A, the BS includes a Radio Frequency (RF) receiver 102, an OFDM demodulator 104, a subcarrier demapper 106, a symbol demodulator 108, a decoder 110, a data buffer 112, a map generator 114, a coder 116, a symbol modulator 118, a subcarrier mapper 120, an OFDM modulator 122, an RF transmitter 124, a feedback information analyzer 126, a headroom calculator 128, an average transfer rate calculator 130, and an uplink scheduler 132.

The RF receiver 102 down-converts an RF-band signal received through an antenna into a base-band signal. The OFDM demodulator 104 divides a signal provided from the RF receiver 102 in a unit of OFDM symbols, removes a Cyclic Prefix (CP) from the signal, and restores frequency-domain signals by performing a Fast Fourier Transform (FFT) operation. The subcarrier demapper 106 divides the frequency-domain signals according to a unit of processing. For example, the subcarrier demapper 106 provides the feedback information analyzer 126 with a signal received through a feedback channel, and provides the symbol demodulator 108 with data signals. The symbol demodulator 108 converts the data signals into a bit-stream by performing demodulation. The decoder 110 restores an information bit-stream by performing channel decoding on the bit-stream.

The data buffer 112 temporarily stores data transmitted to and received from MSs. The map generator 114 generates an uplink MAP message to announce a result of uplink resource allocation performed by the uplink scheduler 132. The coder 116 performs channel coding on the information bit-stream provided from the uplink scheduler 132 and the data buffer 112. The symbol modulator 118 converts the channel-coded bit-stream into complex symbols by performing modulation. The subcarrier mapper 120 maps the complex symbols to a frequency domain. The OFDM modulator 122 converts the complex symbols mapped to the frequency domain by performing an Inverse Fast Fourier Transform (IFFT) operation into time-domain signals, and configures an OFDM symbol by inserting a CP. The RF transmitter 124 up-converts a base-band signal into an RF-band signal, and transmits the RF-band signal through an antenna.

The feedback information analyzer 126 analyzes a signal received through a feedback channel, and thus verifies information fed back from the MSs. In particular, the feedback information analyzer 126 verifies downlink CINR information of an MS and uplink Tx power information of the MS, and then provides the downlink CINR information to the uplink scheduler 132 and provides the uplink Tx power information to the headroom calculator 128.

The headroom calculator 128 calculates a headroom of each MS, i.e., calculates a difference value between maximum Tx power and currently used Tx power of each MS, and thereafter normalizes the difference value according to a reference MCS level. The maximum Tx power of each MS is a parameter controlled by the BS, and the currently used Tx power is verified by the feedback information analyzer 126.

The average transfer rate calculator 130 calculates an uplink average transfer rate of each MS. The uplink average transfer rate may be calculated only for successfully received or transmitted data. If this calculation is performed on only the successfully received data, the average transfer rate calculator 130 calculates an average transfer rate for received data that is successfully decoded by the decoder 110. Otherwise, if this calculation is performed on the successfully transmitted data, the average transfer rate calculator 130 calculates an average transfer rate by using an MCS level and a resource allocated to each MS by the uplink scheduler 132. Further, the average transfer rate calculator 130 provides the uplink scheduler 132 with the uplink average transfer rate of each MS.

The uplink scheduler 132 allocates an uplink resource to each MS by determining uplink scheduling priorities of MSs, and thereafter allocates uplink resources according to the priorities. In particular, in a process of determining the uplink scheduling priorities, the uplink scheduler 132 determines the uplink scheduling priorities by considering a level of other-cell interference. In other words, the uplink scheduler 132 calculates a priority index of each MS so that an MS having a low downlink CINR has a low priority.

More specifically, as illustrated in FIG. 1B, the uplink scheduler 132 includes an MCS determination unit 150, a basic priority determination unit 152, a correction value calculation unit 154, a final priority determination unit 156, and a resource allocation unit 158.

The MCS determination unit 150 determines an MCS level to be used by each MS for uplink communication by using at least one of information elements selected from an average transfer rate calculated by the average transfer rate calculator 130, a headroom calculated by the headroom calculator 128, and a downlink CINR verified by the feedback information analyzer 126.

The basic priority determination unit 152 calculates a basic priority metric of each MS by using the average transfer rate calculated by the average transfer rate calculator 130 and the headroom calculated by the headroom calculator 128. Herein, the basic priority metric is an uplink scheduling priority index that is generated without considering an interference level. For example, the basic priority determination unit 152 calculates the basic priority metric according to the PF scheme as shown in Equation (1). In other words, the basic priority determination unit 152 calculates the basic priority metric as a ratio of an allocatable data transfer rate and a current average data transfer rate by using the headroom of each MS.

The correction value calculation unit 154 calculates a correction value for considering the interference level with respect to the basic priority metric by using the headroom calculated by the headroom calculator 128 and the downlink CINR verified by the feedback information analyzer 126. The correction value is calculated by using a difference value between the headroom of each MS and the downlink CINR. For example, the correction value calculation unit 154 calculates the correction value as shown in Equation (3). In other words, the correction value calculation unit 154 calculates the correction value by calculating 10 to the power of the product between a specific weight and a maximum integer less than a difference value between the headroom and the downlink CINR.

The final priority determination unit 156 calculates a final priority metric of each MS, that is, a priority index for which the interference level is considered, by using the basic priority metric and the correction value. That is, the final priority determination unit 156 calculates the final priority metric of each MS by multiplying the basic priority metric by the correction value. The resource allocation unit 158 determines a size and position of a resource to be used by each MS according to the uplink scheduling priority and the MCS level of each MS. That is, the resource allocation unit 158 determines how many slots will be used by each MS and determines in which physical position a slot to be used will be located.

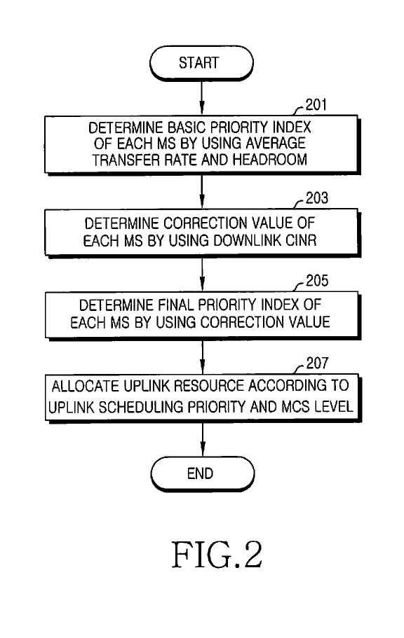

FIG. 2 illustrates a process of determining an uplink scheduling priority by a BS in a broadband wireless communication system according to the present invention.

Referring to FIG. 2, the BS determines a basic priority metric of each MS by using an uplink average transfer rate and a headroom in step 201. The basic priority metric is an uplink scheduling priority index that is generated without considering an interference level. That is, the BS calculates the basic priority metric as a ratio of an allocatable data transfer rate and a current average data transfer rate by using a headroom of each MS. For example, the BS calculates the basic priority metric according to the PF scheme as shown in Equation (1).

After calculating the basic priority index, in step 203, the BS determines a correction value for considering interference occurrence information by using a downlink CINR of each MS. The correction value is calculated by using a difference value between the downlink CINR and the headroom of each MS. That is, the BS calculates the correction value by calculating 10 to the power of the product between a specific weight and a maximum integer less than the difference value. Therefore, the higher the difference between the headroom and the downlink CINR, the lower the correction value. For example, the BS calculates the correction value as shown in Equation (3).

After calculating the correction value, in step 205, the BS determines a final priority metric of each MS, i.e., a priority index for which an interference level is considered, by using the correction value. In other words, the BS calculates the final priority metric of each MS by multiplying the basic priority metric by the correction value. That is, the BS determines an uplink scheduling priority.

After calculating the final priority metric, in step 207, the BS allocates an uplink resource according to the uplink scheduling priority and an MCS level of each MS. In other words, the BS determines a physical size and position of a resource to be used by each MS according the MCS level and the uplink scheduling priority of each MS.

According to the structure of the BS and the process of operating the BS described above, a correction value is calculated by using a downlink CINR. The CINR is one of parameters of representing channel quality, and can be replaced with other types of channel quality values such as a Signal to Interference and Noise Ratio (SINR) or a Signal to Noise Ratio (SNR).

An uplink scheduling priority is determined by considering influence of interference in a broadband wireless communication system, and thus a level of other-cell interference decreases. Accordingly, a system coverage extends, and an average data transfer rate increases.

Although the present invention has been described with reference to certain embodiments, various changes and modifications may be suggested to one skilled in the art. It is intended that the present disclosure encompass such changes and modifications as fall within the scope of the appended claims.

What is claimed is:

1. An apparatus for a Base Station (BS) in a broadband wireless communication system, the apparatus comprising:
a basic priority determination unit for determining a basic priority metric of at least one Mobile Station (MS);
a calculation unit for determining a correction value for considering an interference level with respect to the basic priority metric by using downlink channel quality of each MS; and
a final priority determination unit for determining an uplink scheduling priority by calculating a final priority metric by using the correction value.

2. The apparatus of claim 1, wherein the basic priority determination unit determines the basic priority metric according to a Proportional Fair (PF) scheme.

3. The apparatus of claim 1, wherein the calculation unit determines the correction value by using downlink channel quality and a headroom of each MS.

4. The apparatus of claim 3, wherein the calculation unit determines the correction value by using a difference value between the headroom and the downlink channel quality.

5. The apparatus of claim 4, wherein the calculation unit determines the correction value of each MS under the condition that the correction value decreases as the difference value increases.

6. The apparatus of claim 5, wherein the calculation unit determines the correction value according to the following Equation:
$${10}^{\frac{- α ⌊ {( {R}_{h} )}_{dB} - {( DLCIQI )}_{dB} ⌋}{10}} ,$$
where α denotes a weight for regulating a contribution level of a headroom and downlink channel quality, Rₕ denotes a normalized headroom of an MS, DLCQI denotes downlink channel quality of the MS, and └•┘ denotes a floor function.

7. The apparatus of claim 1, wherein the final priority determination unit determines the final priority metric by multiplying the basic priority metric by the correction value.

8. The apparatus of claim 1, further comprising:
an allocation unit for allocating an uplink resource to each MS according to the uplink scheduling priority.

9. A method of operating a Base Station (BS) in a broadband wireless communication system, the method comprising:
determining a basic priority metric of at least one Mobile Station (MS);
determining a correction value for considering an interference level with respect to the basic priority metric by using downlink channel quality of each MS; and
determining an uplink scheduling priority by calculating a final priority metric by using the correction value.

10. The method of claim 9, wherein the basic priority metric is determined according to a Proportional Fair (PF) scheme.

11. The method of claim 9, wherein the correction value is determined by using downlink channel quality and a headroom of each MS.

12. The method of claim 11, wherein the correction value is determined by using a difference value between the headroom and the downlink channel quality.

13. The method of claim 12, wherein the correction value of each MS is determined under the condition that the correction value decreases as the difference value increases.

14. The method of claim 13, wherein the correction value is calculated according to the following Equation:
$${10}^{\frac{- α ⌊ {( {R}_{h} )}_{dB} - {( DLCQI )}_{dB} ⌋}{10}} ,$$
where α denotes a weight for regulating a contribution level of a headroom and downlink channel quality, Rₕ denotes a normalized headroom of an MS, DLCQI denotes downlink channel quality of the MS, and └•┘ denotes a floor function.

15. The method of claim 9, wherein the final priority metric is determined by multiplying the basic priority metric by the correction value.

16. The method of claim 9, further comprising allocating an uplink resource to each MS according to the uplink scheduling priority.
